(19) United States
(12) Patent Application Publication
(10) Pub. No.: US 2019/0132673 A1
(43) Pub. Date: May 2, 2019

(54) MICROPHONE ARRANGEMENT

(71) Applicant: INSTITUT FUR RUNDFUNKTECHNIK GMBH, Munchen (DE)

(72) Inventor: Roman Stumpner, Munchen (DE)

(21) Appl. No.: 16/092,162

(22) PCT Filed: Apr. 11, 2017
(86) PCT No.: PCT/EP2017/058619

§ 371 Date: Oct. 8, 2018

(30) Foreign Application Priority Data
Apr. 11, 2016 (IT) 102016000037055

(51) Int. Cl. H04R 3/00; H04R 5/027; H04R 1/40

(52) U.S. Cl. CPC H04R 3/005; H04R 1/406; H04R 5/027

(57) ABSTRACT

Microphone arrangement includes a microphone capsule having a dimension such, that it can be accommodated at the far end of an ear canal of an artificial head, and a microphone circuit, provided with a first output for supplying a first microphone arrangement output signal which is a measure for a sound pressure level (SPL) measured by the microphone arrangement, wherein the microphone arrangement is further provided with a second output for supplying a second microphone arrangement output signal, which is a measure for an acoustic impedance measured by the microphone arrangement, the microphone capsule thereto having a diaphragm for positioning at the far end of the ear canal.

### BACKGROUND OF THE INVENTION

### 1. The Field of the Invention

The invention relates to a microphone arrangement comprising a microphone capsule having a dimension such, that it can be accommodated at the far end of the ear canal of an artificial head, and comprising a microphone circuit. The invention relates also to a microphone capsule and a microphone circuit in the microphone arrangement.

### 2. Present State of the Art

A microphone arrangement for insertion in an ear canal of a human ear is known from US patent document 5692859.

This known microphone arrangement is unable to replicate correctly the localization capabilities of human hearing and the SLD effect (SLD=sound level loudness divergence).

The object of the invention is to propose a microphone arrangement that is able to replicate correctly the localization capabilities of human hearing and the SLD effect (SLD=sound level loudness divergence).

### SUMMARY OF THE INVENTION

To this end the microphone arrangement according to the invention is characterized according to the features of the 1st claim. Further exemplary embodiments of the microphone arrangement according to the invention are defined by the other claims.

The invention is based on the following knowledge.

It is known that, with the same sound pressure level in the ear canal, headphones produce less loudness than loudspeakers (SLD effect), if the presentation of sound signals is diotic or monotic. Furthermore, it is known that, when hearing naturally, human hearing enables the reliable localization of sound events in the median plane of the head, although only spectral features of the outer-ear transmission function can be used for this. This capability is not lost even with different spectral compositions of the noise event. With headphone reproduction, by contrast, this localization capability is limited considerably. New study results give reason to suppose that the SLD effect and the lack of localization capability in the median plane in the case of headphone reproduction have an interrelationship based on the sound field impedance on the ear. With headphones, this can differ considerably from natural sound sources or loudspeakers. Spectral features caused by the head and body are evident in highs and lows in the frequency response. However, these are also associated with certain changes in the sound field impedance. If the human hearing does in fact gain spectral features from an impedance measurement and not only by way of the sound pressure, the hearing could determine the directional localization irrespective of the spectrum of the sound source. This would explain why the capabilities of directional localization in the median plane are poorer with headphone reproduction.

Because the microphone arrangement provides not only the sound pressure signal, but also a signal that is a measure for the sound field impedance, more acoustic features of sound sources relating to sound field impedance can be measured than with the currently usual methods of sound pressure measurement.

### BRIEF DESCRIPTION OF THE FIGURES

The invention is explained further in the description of figures below with the help of a few exemplary embodiments.

It shows:

FIG. 1 the basic principle of the microphone arrangement according to the invention,

FIG. 2 an exemplary embodiment of the microphone arrangement according to the invention,

FIG. 3 an exemplary embodiment of the driver signal generation circuit in the microphone arrangement in FIG. 2,

FIG. 4 a second exemplary embodiment of the driver signal generation circuit,

FIG. 5 some signals in the microphone circuit,

FIG. 6 another exemplary embodiment of the microphone capsule,

FIG. 7 yet another exemplary embodiment of the microphone capsule, and

FIG. 8 how a microphone arrangement according to the invention can be included in an artificial head.

### DETAILED DESCRIPTION OF THE PREFERRED EMBODIMENTS

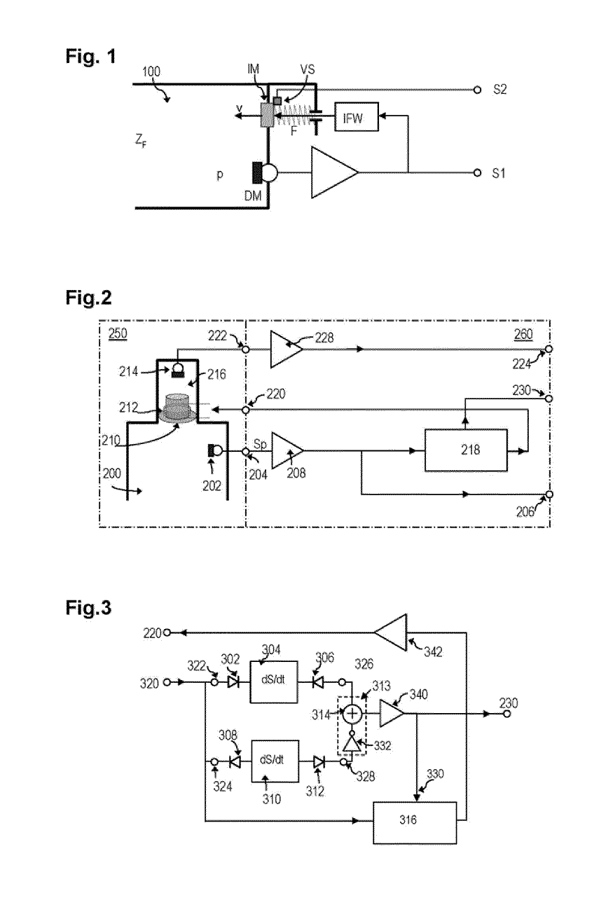

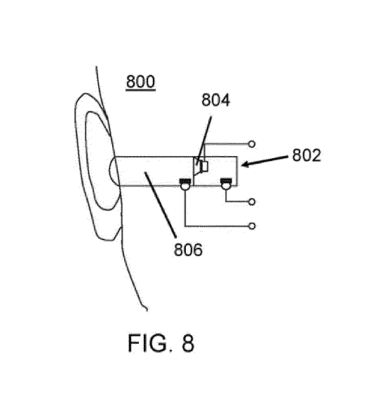

FIG. 1 shows schematically the basic principle of the microphone capsule according to the invention. The basic principle is based on the fact that the hearing behaviour of the human ear is to be replicated as well as possible by the microphone arrangement according to the invention. The microphone capsule in the microphone arrangement according to the invention can be characterized schematically as follows:
1) It has a pressure microphone (DM) and an impedance diaphragm (IM).
2) The impedance diaphragm exerts a force onto the sound field and responds with a velocity that is dependent on the sound field impedance and the pressure. The impedance diaphragm counteracts with a greater force than that to which it is exposed by the sound field itself.
3) The microphone arrangement supplies two signals by means of the microphone circuit: a sound pressure signal S1 corresponding to the sound pressure p, and a signal S2 corresponding to the velocity v of the impedance diaphragm IM, p the sound pressure in the sound entrance opening 100 and ZF the sound field impedance at the microphone input.
4) If the microphone arrangement is accommodated at the far end of the ear canal of an artificial head, see FIG. 8 in this regard, the diaphragm is located at the far end of the ear canal, i.e., where the eardrum is located in a human ear. In this position the diaphragm experiences an acoustic impedance which is a measure for the acoustic impedance of the ear canal of the artificial head and the acoustic impedance at the entrance of the ear canal, as a result of acoustic waves that come from an acoustic source outside the artificial head and are transmitted to the artificial head.

The mode of action is as follows.

With the signal S1 of the pressure microphone and of a current-force transducer IFW the impedance diaphragm IM is tensioned by way of spring F in the phases of rising pressure (+/−). In the phases of decreasing pressure the current-force transducer IFW is decoupled from the impedance diaphragm and the force stored in the spring is returned to the sound field via the impedance diaphragm IM. The force that is stored in the spring is higher than the force that the sound field itself exerts onto the impedance diaphragm. The spring accelerates the sound field and senses its resistance. The velocity v, with which the impedance diaphragm is moved by the tensioned spring, depends on this sound field impedance. The velocity v is converted by a velocity sensor VS into a corresponding electrical signal S2. Here, the velocity signal during the decreasing pressure phase is crucial.

There is an interrelationship between this signal and the sound field impedance.

This knowledge leads to a solution for the microphone arrangement according to the invention as shown in FIG. 2. In this exemplary embodiment the impedance diaphragm and the current-force transducer is realized with the help of an electrodynamic transducer.

The microphone arrangement according to the invention in FIG. 2 contains a microphone capsule 250 and a microphone circuit 260. The microphone capsule 250 contains a first microphone 202 for measuring the sound pressure in a sound entrance space 200, with an output 204.

The microphone capsule 250 is further provided with a diaphragm 210 and provided with a second microphone 214 with an output 222. The second microphone 214 is accommodated in a second space 216. The second space 216 is coupled to the sound entrance space 200 via an opening. The diaphragm 210 is accommodated in this opening and in size is equal to the size of said opening. Thus, the diaphragm closes said opening completely. The second microphone 214 is accommodated in the second space 216 and measures the sound pressure in the second space 216.

The diaphragm 210 is provided with a driver arrangement, in this exemplary embodiment in the form of a driver coil 212. The system forms an electrodynamic transducer.

The microphone circuit 260 contains a first input 204 coupled to the output of the first microphone 202, a second input 222 coupled to the output of the second microphone 214, and a third output 220 for supplying a driver signal to the driver coil 212. The first input 204 is coupled to the first output 206 of the microphone circuit 260—if appropriate, by way of an amplifier circuit 208—for supplying the first microphone signal, which is a measure for a sound pressure (SPL=sound pressure level) measured by the first microphone 202. The second input 222 is coupled to the second output 224 of the microphone circuit 260—if appropriate, by way of an amplifier circuit 228—for supplying the second microphone signal, which is a measure for an acoustic impedance measured by the microphone arrangement 250, 260, as explained later in more detail.

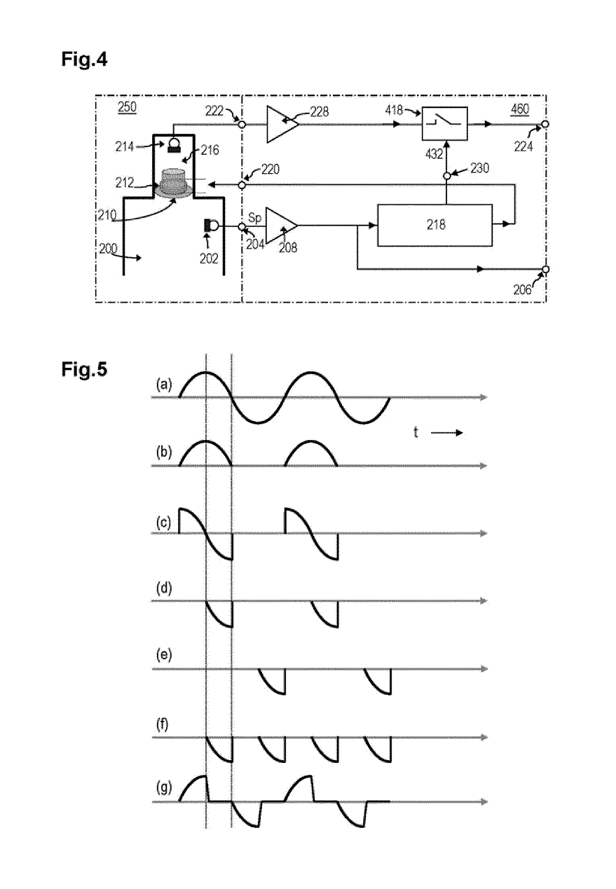

The microphone circuit 260 contains further a driver signal generation circuit 218, with an input coupled to the first input 204 of the microphone circuit 260 and an output coupled to the third output 220 of the microphone circuit 260, to control the driver coil 212. The driver signal generation circuit 218 may contain a further output 230. The signal at this output 230 is a blanking signal which is required in order to generate a better impedance signal, as explained further with the help of FIG. 4. In the exemplary embodiment of FIG. 2, an external controllable switch arrangement, such as switch arrangement 418 in FIG. 4, is required to generate the better impedance signal.

During the increasing pressure phase of the positive half-wave, the signal processing in the driver signal generation circuit 218 generates an electrical voltage for the electrodynamic transducer, such that its diaphragm is forced into the hollow space 216 and generates a pressure there. For the increasing pressure phase of the negative half-wave a correspondingly inverted voltage is generated. During the respective falling pressure phases the voltages are switched off, such that the electrodynamic transducer becomes current-free. During the current-free phase, the diaphragm 210 of the transducer is forced into the initial position only by the stored pressure in the hollow space 216. The blanking signal at output 230 of the microphone circuit 260 characterizes the phase of the decreasing pressure. The signal of the second microphone 214, which is available at output 224, is evaluated only during the period of decreasing pressure.

FIG. 3 shows an exemplary embodiment of the driver signal generation circuit 218 in FIG. 2.

The driver signal generation circuit 218 is provided with a first series arrangement consisting of a first rectifier 302, a first differentiator 304 and a second rectifier 306, a second series arrangement consisting of a third rectifier 308, a second differentiator 310 and a fourth rectifier 312, a signal combination arrangement 313, and a controllable modulator arrangement 316. The input 320 of the driver signal generation circuit is coupled to first terminals 322, 324 of the two series arrangements and to an input of the modulator arrangement 316. Second terminals 326, 328 of the two series arrangements are coupled to corresponding inputs of the signal combination arrangement 313. An output of the signal combination arrangement 313 is coupled to a control input 330 of the modulator arrangement 316—if appropriate, by way of an amplifier arrangement 340—and, if appropriate, to the output 230. An output of the modulator arrangement 316 is coupled to the output 220 of the driver signal generation circuit—if appropriate, by way of an amplifier arrangement 342.

The signal combination arrangement 313 can composed in different ways. For example, FIG. 3 shows that the signal combination arrangement 313 can composed of a signal addition device 314 and an inverter 332. Thus, the signal combination arrangement 313 is in fact a subtraction device. However, if the signal on terminal 328 is already present in inverted form, the signal combination arrangement 313 is an addition device.

The modulator arrangement 316 is preferably an amplitude modulator device. The modulator arrangement 316 can also be embodied as a controllable switch arrangement, e.g., as shown in FIG. 4 as controllable switch arrangement 418.

The first rectifier 302 and the fourth rectifier 312 of the first and second series arrangement comprise a rectifying function in a first direction. The second and third rectifier 306 and 308, respectively, of the first and second series arrangement comprise a rectifying function in the opposite direction to the first specified direction.

The rectifiers 302, 306, 308 and 312 are preferably precision rectifiers. Such rectifiers are able also to rectify low-amplitude signals correctly.

The mode of action of the driver signal generation circuit 218 on the behaviour of the microphone arrangement consists in determining the phases of the falling sound pressure for the positive and negative half-waves, in order to thereby generate a signal, with the help of which the electrodynamic transducer can be made current-free and in order to distinguish the time interval during which the evaluation of the signal of the second microphone 214 is carried out. This signal section contains the information on the velocity with which the diaphragm of the electrodynamic transducer moves back into the rest position.

FIG. 4 shows another exemplary embodiment of the microphone arrangement. The microphone capsule 250 in the exemplary embodiment in FIG. 4 is the same as the microphone capsule in FIG. 2. Whereas the microphone circuit 260 in FIG. 2 requires the signal outputs 224 and 230 in order to determine from them, in further processing, a signal that is a better measure of the sound field impedance, the microphone circuit 460 in FIG. 4 requires only the signal output 224. The output 230 of the driver signal generation circuit 218 is coupled to the control input 432 of the analogue switch 418, the input of which, in turn, is connected with the input 222 of the microphone circuit 460. The output of the analogue switch 418 is connected with the output 224 of the microphone circuit 460. In all other properties the microphone circuit 460 is identical to the microphone circuit 260.

FIG. 5 shows some signals of the driver signal generation circuit 218. A sinusoidal sound pressure signal is converted by the first microphone 202 into a signal that is shown in FIG. 5a. This signal enters the driver signal generation circuit 218 via the input 320. In the first series arrangement after the rectifier 302, a signal as shown in FIG. 5b is produced, after the differentiator 304, the signal corresponds to FIG. 5c, and after the second rectifier 306, a signal as shown in FIG. 5d is produced. The microphone signal of input 320 passes likewise through the second series arrangement 308, 310, 312, 332. At the output of the inverter 332, there is a signal present, as shown in FIG. 5e. FIG. 5f shows the signal after the signal adder 314. This signal also corresponds to the blanking signal at the output 230 of the driver signal generation circuit 218. The output of the modulator 316 supplies the signal according to FIG. 5g with which the electrodynamic transducer is fed by way of the output 220 of the microphone circuit 260 and 460. FIG. 5g makes it clear that the blanking signal causes the switching-off of the signal voltage for the electrodynamic transducer at the times of decreasing sound pressure.

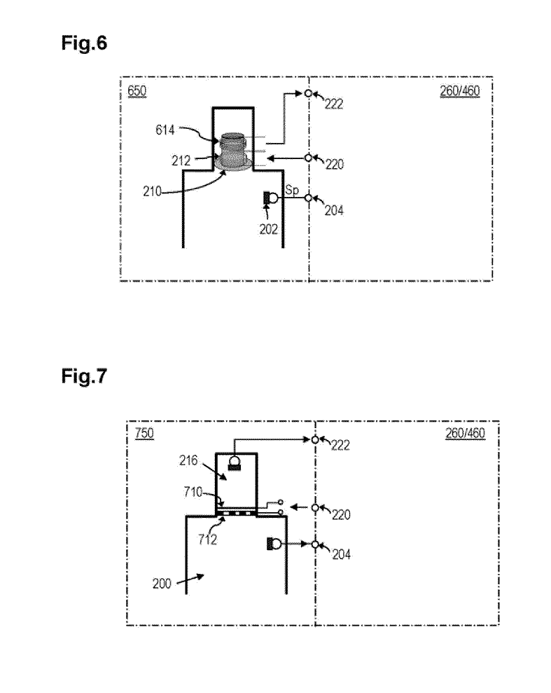

FIG. 6 shows schematically a second exemplary embodiment of the microphone capsule, which is indicated here with reference number 650. The difference in comparison with the microphone capsule from FIG. 2 is that, instead of the second microphone being realized as a separate microphone, like the microphone 214 in FIG. 2 is formed, it has been realized as an additional coil 614, which is accommodated onto the diaphragm 210. The output of the coil 614 is coupled with the second input 222 of the microphone circuit (either the microphone circuit 260 or the microphone circuit 460).

FIG. 7 shows schematically a third exemplary embodiment of the microphone capsule, which is indicated here with reference number 750. The difference in comparison with the microphone capsule from FIG. 2 is now that, instead of a diaphragm 210 with driver coil 212 being provided in the opening between the sound entrance space 200 and the second space 216, a diaphragm equipped with a conductive layer 710 is now provided, which, together with a counter-electrode 712, forms an electrostatic transducer. This transducer is controlled by means of the driver signal which is fed to the transducer via the terminal 220.

FIG. 8 shows schematically how the microphone arrangement 802 according to the invention can be accommodated in an artificial head 800. As can be seen, the diaphragm 210, shown here schematically as loudspeaker 804, is accommodated at the far end of the ear canal 806 of the artificial head and closes this end of the ear canal.

The function of this diaphragm in the microphone arrangement is that it is to be viewed as imitation of a part of the eardrum of a human ear and detects the acoustic waves entering the ear canal in the same way. In fact, an acoustic impedance is determined by this diaphragm in dependence on acoustic waves that enter the ear canal of the artificial head.

1. A microphone arrangement comprising:
a microphone capsule having a dimension such, that it can be accommodated at the far end of an ear canal of an artificial head;
a microphone circuit, provided with a first output for supplying a first microphone arrangement output signal which is a measure for a sound pressure level (SPL) measured by the microphone arrangement; and
a second output for supplying a second microphone arrangement output signal, which is a measure for an acoustic impedance measured by the microphone arrangement, the microphone capsule thereto comprising a diaphragm for positioning at said far end of the ear canal.

2. The microphone arrangement as claimed in claim 1, wherein the said diaphragm is acting as an imitation of the eardrum of a human ear.

3. The microphone arrangement as claimed in claim 1, wherein when accommodated at said far end of the ear canal of said artificial head, the second microphone arrangement output signal is a measure of the acoustic impedance of said ear canal and the acoustic impedance at the sound entrance of said ear canal.

4. The microphone arrangement as claimed in claim 1, where the microphone capsule is provided with a first microphone for measuring the sound pressure level in a sound entrance space of the microphone capsule, and which has an output coupled to the first output of the microphone arrangement, characterized in that, the microphone capsule is further provided with
said diaphragm,
a second microphone,
a second space, and
that the second space is coupled to the sound entrance space via an opening, that the diaphragm is accommodated in said opening and in size is equal to the size of said opening, thereby closing said opening, that the diaphragm is provided with an electro-mechanic driver arrangement, and that the second microphone is accommodated in the second space.

5. The microphone arrangement as claimed in claim 4, wherein the second microphone is a microphone for measuring the sound pressure level in the second space.

6. The microphone arrangement as claimed in claim 4, wherein the diaphragm which is provided with the electro-mechanic driver arrangement is a diaphragm provided with a driver coil.

7. The microphone arrangement as claimed in claim 4, wherein the diaphragm provided with the electro-mechanic driver arrangement is in the form of an electrostatic transducer.

8. The microphone arrangement as claimed in claim 4, wherein the microphone circuit has a first input coupled to an output of the first microphone, a second Input coupled to an output of the second microphone, and a third output for supplying a river signal, and the third output is coupled to an input of the driver arrangement.

9. The microphone arrangement as claimed in claim 8, wherein the first input of the microphone circuit is coupled to the first output of the microphone circuit, and the second input of the microphone circuit is coupled to the second output of the microphone circuit.

10. The microphone arrangement as claimed in claim 9, wherein the microphone circuit is provided with a driver signal generation circuit having an input coupled to the first input of the microphone circuit and an output coupled to the third output of the microphone circuit.

11. A microphone arrangement as claimed in claim 10, characterized in that, the driver signal generation circuit is provided with
a first series arrangement of a first rectifier, a first differentiator and a second rectifier,
a second series arrangement of a third rectifier, a second differentiator and a fourth rectifier,
a signal combination arrangement, and
a controllable modulator arrangement,
that the input of the driver signal generation circuit is coupled to first terminals of both series arrangements and to an input of the modulator arrangement, that second terminals of both series arrangements are coupled to corresponding inputs of the signal combination arrangement, an output of the signal combination arrangement being coupled to a control input of the modulator arrangement, that an output of the modulator arrangement is coupled to the output of the driver signal generation circuit.

12. The microphone arrangement as claimed in claim 11, wherein the first rectifier and the fourth rectifier of the first and second series arrangement, respectively, exhibit a rectifying function in a first direction, and the second and third rectifier of the first and second series arrangement, respectively, exhibit a rectifying function in a direction reverse to the first mentioned direction.

13. The microphone arrangement as claimed in claim 11, wherein the microphone circuit is further provided with a controllable switch arrangement accommodated between the second input and the second output of the microphone circuit, and that the output of the signal combination arrangement is also coupled to a control input of the switch arrangement.

14. The microphone arrangement as claimed in claim 4, wherein the second microphone is realized in the form of a coil accommodated on diaphragm.

15. A Microphone arrangement comprising: a microphone capsule and a microphone circuit, provided with a first output for supplying a first microphone arrangement output signal which is a measure for a sound pressure level (SPL) measured by the microphone arrangement, wherein the microphone capsule is provided with a first microphone for measuring the sound pressure level in a sound entrance space of the microphone capsule, and which has an output coupled to the first output of the microphone arrangement, the microphone capsule being further provided with:
a diaphragm,
a second microphone,
a second space, and
that the second space is coupled to the sound entrance space via an opening, that the diaphragm is accommodated in said opening and in size is equal to the size of said opening, thereby closing said opening, that the diaphragm is provided with an electro-mechanic driver arrangement, and that the second microphone is accommodated in the second space.

16. A microphone arrangement comprising: a microphone capsule having a dimension such, that it can be accommodated at the far end of an ear canal of an artificial head, and a microphone circuit, provided with a first output for supplying a first microphone arrangement output signal which is a measure for a sound pressure level (SPL) measured by the microphone arrangement, wherein the microphone arrangement is further provided with a second output for supplying a second microphone arrangement output signal, which is a measure of a sound velocity level (SVL) measured by the microphone arrangement, the microphone capsule thereto comprising a diaphragm for positioning at said far end of the ear canal.

17.-19. (canceled)
